(19) United States
(12) Patent Application Publication
(10) Pub. No.: US 2013/0238992 A1
(43) Pub. Date: Sep. 12, 2013

(54) Method and Device for Content Control Based on Data Link Context

(71) Applicants: Wen Hao Zhang, Lake Villa, IL (US); Chen Je Huang, Chicago, IL (US); Long Ling, Jiangsu (CN); Andrew K. Wells, Lindenhurst, IL (US)

(72) Inventors: Wen Hao Zhang, Lake Villa, IL (US); Chen Je Huang, Chicago, IL (US); Long Ling, Jiangsu (CN); Andrew K. Wells, Lindenhurst, IL (US)

(73) Assignee: Motorola Mobility, Inc., Libertyville, IL (US)

(21) Appl. No.: 13/415,510

(22) Filed: Mar. 8, 2012

(51) Int. Cl. G06F 3/048

(52) U.S. Cl. 715/716

(57) ABSTRACT

In embodiments of content control based on data link context, a portable electronic device (102) detects when communicatively linked to a media rendering device (114) via a data link (122). The portable electronic device (102) can then determine whether the data link (122) was previously utilized to communicatively link the portable electronic device (102) to the media rendering device (114). The portable electronic device (102) can then initiate a media control selection menu (128) for display on the portable electronic device (102) if the data link (122) was not previously utilized. Alternatively, the portable electronic device (102) can initiate a media control interface (126) for display on the portable electronic device (102) if the data link (122) was previously utilized, where the media control interface (126) is implemented for user-selection to control media content (106) that is rendered by the media rendering device (114).

### BACKGROUND

A portable device, such as a mobile phone, laptop computer, digital camera, or tablet device, can be connected via a multimedia cable to a display device, such as a television, LCD, or other type of display. Media content, such as digital images and video, that is stored on the portable device can then be displayed on the connected display device, such as to share photos taken with the portable device for viewing with others in a room on a larger display. Typically, a user can connect a portable device to a display device, and then navigate user interfaces and actuatable controls on the portable device to select the media content for display on the display device.

### BRIEF DESCRIPTION OF THE DRAWINGS

Embodiments of content control based on data link context are described with reference to the following Figures. The same numbers may be used throughout to reference like features and components that are shown in the Figures:

FIG. 1 illustrates an example system in which embodiments of content control based on data link context can be implemented.

FIG. 2 illustrates examples of media content control interfaces for display on a portable electronic device in accordance with one or more embodiments of content control based on data link context.

FIG. 3 illustrates additional examples of media content control interfaces for display on a portable electronic device in accordance with one or more embodiments of content control based on data link context.

FIG. 4 illustrates an example data table that correlates data link identifiers with media rendering device types and recently-used media control interfaces in accordance with one or more embodiments of content control based on data link context.

FIG. 5 illustrates example method(s) of content control based on data link context in accordance with one or more embodiments.

FIG. 6 illustrates various components of an example electronic device that can implement embodiments of content control based on data link context.

### DETAILED DESCRIPTION

In embodiments of content control based on data link context, a portable electronic device can be implemented to automatically display a most-recent, previously displayed media control interface on the portable electronic device when a data link to a peripheral media rendering device is detected. For example, a mobile phone can detect a data link to a peripheral display device and a most-recent, previously displayed media control interface (e.g., a music control interface, an images slideshow control interface, a video control interface, or combination thereof) is initiated for display on the mobile phone.

An identifiable data link, such as a device dock or identifiable HDMI cable, can be detected when the portable electronic device is connected to a media rendering device, and the most-recent, previously displayed media control interface that correlates to the identified data link can be initiated for display on the portable electronic device. For example, a user may connect a mobile phone to a peripheral display device that was previously used to display photos, and when the data link that connects the devices is detected, the images slideshow control interface is automatically initiated for display on the mobile phone to resume displaying the photos.

Alternatively, a non-identifiable data link, such as an HDMI cable or other non-identifiable communication link, can be detected when the portable electronic device is connected to the media rendering device, and the most-recent, previously displayed media control interface can be initiated for display on the portable electronic device. Alternatively, the non-identifiable data link can be detected and, if a media control interface has not been recently displayed, a media control selection menu can be initiated for display as a user interface, from which a user can then select one or a combination of the media control interfaces.

While features and concepts of content control based on data link context can be implemented in any number of different devices, systems, and/or configurations, embodiments of content control based on data link contexture described in the context of the following example devices, systems, and methods.

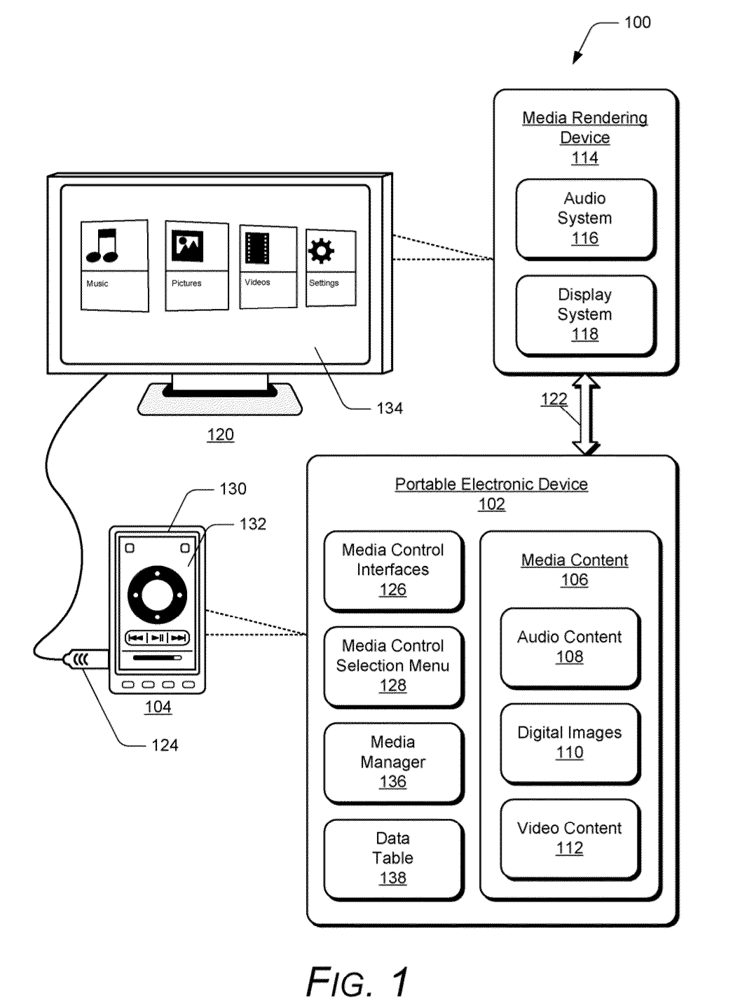

FIG. 1 illustrates an example system 100 in which embodiments of content control based on data link context can be implemented. The example system 100 includes a portable electronic device 102, such as a mobile phone 104, a tablet device, a laptop computer, or a digital camera that has still image and video capture features. The portable electronic device can be implemented with various components, such as one or more processors and memory, as well as with any combination of differing components as further described with reference to the example electronic device shown in FIG. 6. The portable electronic device can capture, store, receive, and/or otherwise maintain media content 106, such as any type of audio content 108, digital images 110, and/or video content 112.

The example system 100 also includes a media rendering device 114 that can be implemented as an audio system 116 and/or a display system 118. The media rendering device may be any one or combination of a display device 120, television, stereo system speakers, or any other type of device that includes the audio system 116 to render audio data and/or the display system 118 to render video and image data. The portable electronic device 102 can be communicatively linked to the media rendering device via a data link 122. For example, a mobile phone can be communicatively linked to the media rendering device that renders the audio content 108 and/or displays the digital images 110 and the video content 112 that is stored on the mobile phone. In this example, the media rendering device 114 is external to the portable electronic device 102 and communicatively linked via the data link 122.

The data link 122 can be implemented as a standard, non-identifiable high-definition multimedia interface (HDMI) cable, or an identifiable HDMI cable, such as the HDMI cable 124 shown communicatively linking the mobile phone 104 and the display device 120. Alternatively, the data link 122 can be implemented as a device dock that connects the portable electronic device 102 to the media rendering device 114 when the portable electronic device is placed into the device dock. An HDMI connector may be implemented as a Type A, Type B (mini), or Type C (micro) cable, as well as other custom or proprietary connectors, and the HDMI connector provides an HD video plus audio interface connection via which the portable electronic device can be communicatively linked to the media rendering device. An identifiable HDMI cable can be identified by the portable electronic device, such as by including a micro-chip in the cable and/or by a unique resistance that is consistent with a particular type of peripheral device connected by the HDMI cable to the portable electronic device. Alternatively or in addition, an identifiable HDMI cable may be identified by a unique code for the cable.

Additionally, an identifiable HDMI cable may be utilized to authenticate a peripheral, such as the media rendering device 114. For example, the portable electronic device 102 can include an authenticator that compares an identifier of a peripheral with a database of identifiers known to be authentic. A peripheral can be authenticated, or determined to be potentially authentic, when the peripheral is a device (or class of devices) previously known to function with the portable electronic device. In implementations, a peripheral may include an authentication module that responds to a cryptographic challenge from the portable electronic device.

In this example, the portable electronic device 102 includes media control interfaces 126 and a media control selection menu 128. The media control interfaces can be displayed on an integrated display 130 of the portable electronic device, such as on the mobile phone 104, for user-selectable control of the various media content 106. For example, the media control interfaces can include a music control interface to control playback of the audio content 108 at the audio system 116, and an example of the music control interface 132 is shown displayed on the integrated display of the mobile phone. The media control interfaces can also include an images slideshow control interface to control displaying the digital images 110 on the display system 118, and a video control interface to control playback of the video content 112 on the audio system and display system.

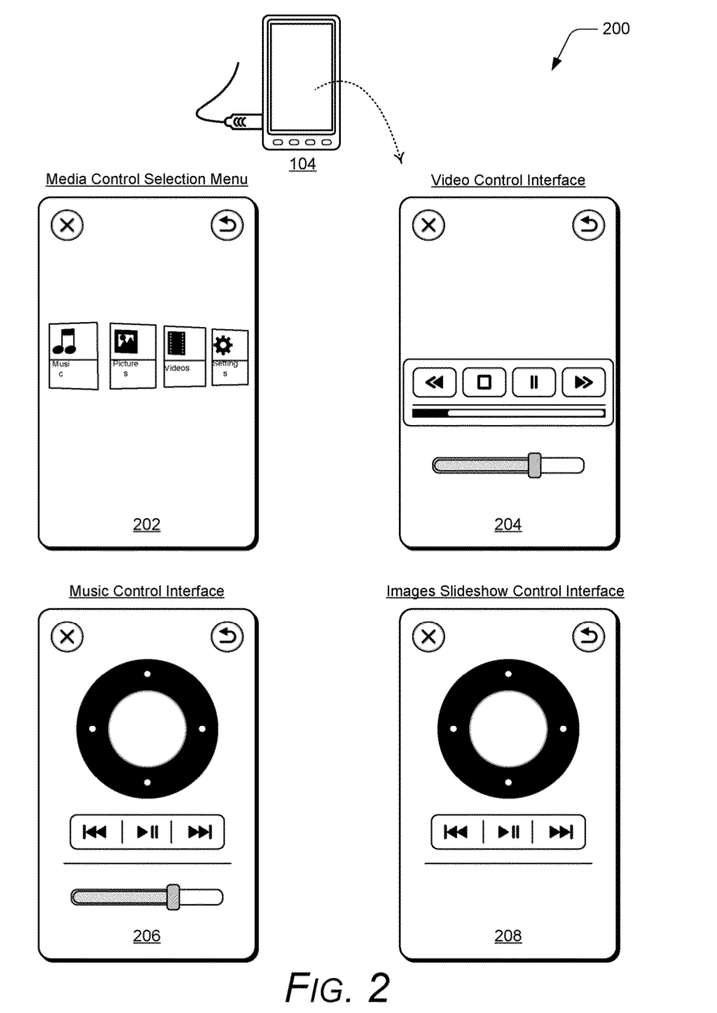

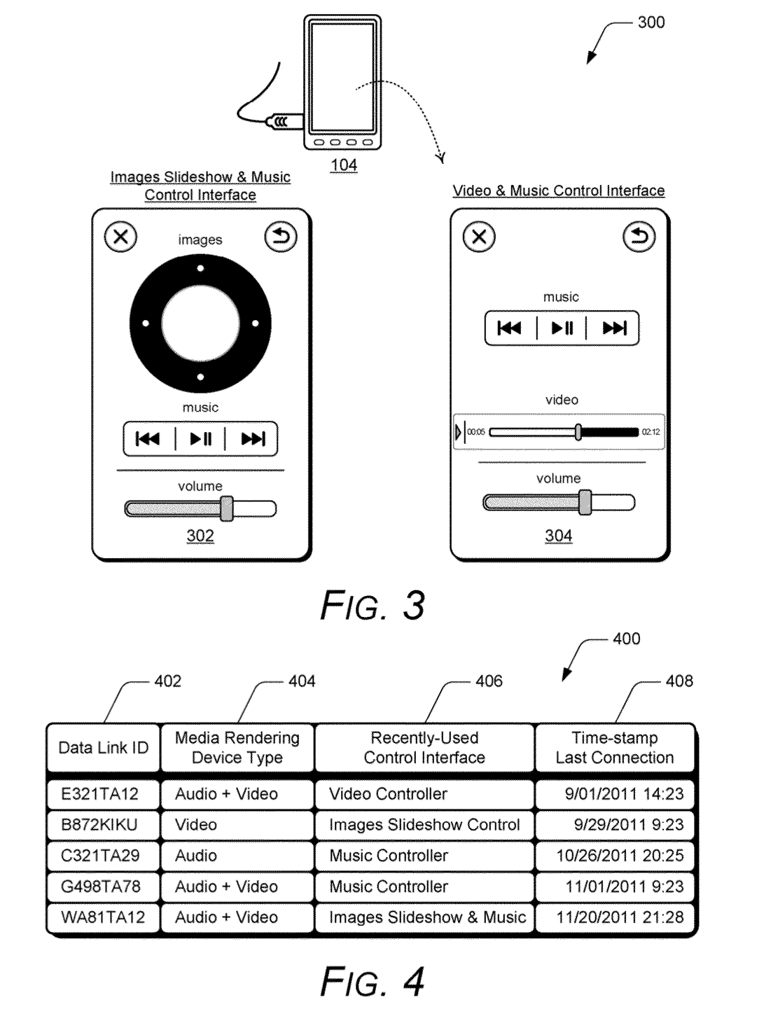

Examples of the media control interfaces 126 are shown and further described with reference to FIG. 2, and examples of combined media content control interfaces are shown and further described with reference to FIG. 3. The media control selection menu 128 can be displayed as a user interface for user-selection of one of the media control interfaces, and an example of the media control selection menu is shown displayed at 134 on the display device 120.

In embodiments, the portable electronic device 102 includes a media manager 136 that can be implemented as computer-executable instructions, such as a software application, and executed by one or more processors to implement the various embodiments of content control based on data link context described herein. The media manager is implemented to detect the data link 122 to the media rendering device 114, such as when a user connects the mobile phone 104 to the display device 120 via the HDMI cable 124. The media manager can then determine whether the data link was previously utilized to communicatively link the portable electronic device to the media rendering device.

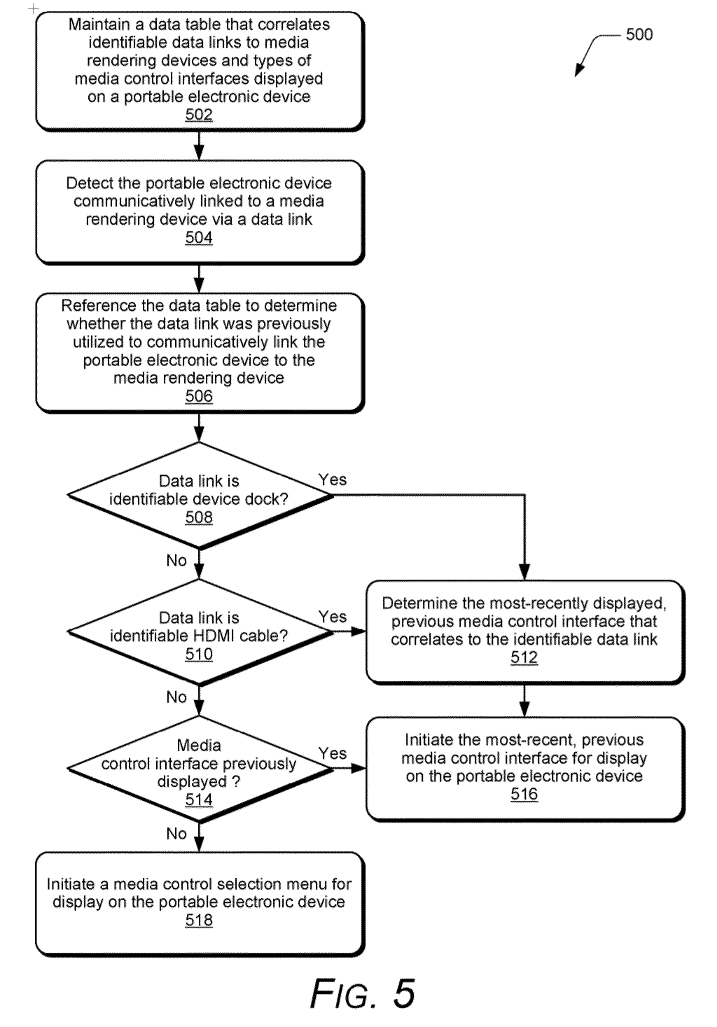

In an implementation, the media manager 136 can identify or determine whether a particular data link was previously utilized from a data table 138 that is maintained on the portable electronic device 102. An example of the data table is shown and further described with reference to FIG. 4. In this example, the data table correlates an identifiable data link to the media rendering device and a type of media control interface that was most-recently displayed on the portable electronic device when communicatively linked to that media rendering device.

Alternatively, the media manager may be implemented to identify whether a particular data link was previously utilized from any other type of memory or data structure used to correlate previous data links, the type of connected media rendering device, and the type of media control interface that was most-recently displayed on the portable electronic device. In implementations, the media manager can also obtain Extended Display Identification Data (EDID) from the media rendering device 114 via the data link, and the EDID structure indicates the display capabilities, such as the resolution and profile, of the display system 118 at the media rendering device.

In embodiments, the media manager 136 can detect an HDMI cable at an HDMI data port of the portable electronic device 102 and initiate the media control selection menu 128 for display, from which a user can then select one of the media control interfaces 126. Alternatively, the media manager 136 can initiate one of the media control interfaces for display, such as the previous, most-recently displayed media control interface (i.e., the media control interface that was displayed when the devices were previously connected via the data link).

For example, when a user initially connects the portable electronic device 102 to the media rendering device 114 via the data link 122, the media manager 136 detects the data link and initiates the media control selection menu 128 for display. The user can then select one of the media control interfaces for display to control playback of media content on the media rendering device, such as the music control interface 132 shown displayed on the mobile phone 104 to control playback of the audio content 108 on the audio system 116. After the playback is finished, the user may disconnect from the data link 122 (or disconnect the data link 122 from the media rendering device 114). When the user subsequently connects the portable electronic device 102 to the media rendering device 114 with the data link 122, such as with the same or a different HDMI cable, the media manager can again detect the data link and initiate the most-recently displayed media control interface, such as the music control interface 132 shown displayed on the mobile phone.

In other embodiments, the media manager 136 can detect identifiable HDMI cables at an HDMI port of the portable electronic device 102 and correlate each different identifiable HDMI cable with a specific media rendering device. For example, a first identifiable HDMI cable may be used as the data link 122 to connect the portable electronic device 102 to the audio system 116, and the media manager 136 determines that the most-recently displayed media control interface associated with the audio system is the music control interface 132 for user control to playback the audio content 108. Alternatively, a second identifiable HDMI cable may be used as the data link to connect the portable electronic device to the display system 118, and the media manager determines that the most-recently displayed media control interface associated with the display system is an images slideshow control interface to control playback of the digital images 110 on the display system. In an implementation, the media manager 136 can first determine an identifiable HDMI cable from a cable identifier and secondarily, may determine a specific media rendering device from a device identifier to correlate the identifiable HDMI cable with the specific media rendering device.

Similarly, the media manager 136 can detect from hardware connectivity when the portable electronic device 102 is positioned in a device dock, which is another example of the data link 122, and the media manager can initiate any of the various media control interfaces 126, the media control selection menu 128, or any other display and/or user interface. The media manager can determine the most-recently displayed media control or selection menu interface from the data table 138, which correlates the device dock and a type of the media control interface that was most-recently displayed on the portable electronic device when positioned in the device dock.

FIG. 2 illustrates examples 200 of media control interfaces for display on a portable electronic device, such as the mobile phone 104 described with reference to FIG. 1. The examples 200 include a media control selection menu 202 from which any one of a video control interface 204, music control interface 206, or images slideshow control interface 208 can be selected by a user for display on the portable electronic device. Each of the different media control interfaces include various user-selectable controls that a user can manipulate to control the respective media content, such as playback of the audio content 108 (FIG. 1) on the audio system 116, displaying the digital images 110 on the display system 118, and/or playback of the video content 112 on the audio system and the display system.

FIG. 3 illustrates examples 300 of content control interfaces for display on a portable electronic device, such as the mobile phone 104 described with reference to FIG. 1. The examples 300 include a combination images slideshow and music control interface 302, and a video and music control interface 304. Each of the different content control interfaces includes various user-selectable controls that a user can manipulate to control the respective combinations of media content. For example, a user can control displaying the digital images 110 (FIG. 1) on the display system 118 while the audio content 108 is played back on the audio system 116. Similarly, a user can control playback of the video content 112 on the display system 118 while separate audio content 108 is also played back on the audio system 116.

FIG. 4 illustrates an example data table 400 that correlates data links to media rendering device types, as well as the most-recently used media control interface for a specific media rendering device. The data table 400 is an example of the data table 138 described with reference to FIG. 1. In this example, the data table 400 includes data link identifiers 402, such as to identify a data link 122 that is an identifiable HDMI cable or device dock. If the data link 122 itself is not identifiable, the table 400 may use an identifier from the media rendering device 114, create a “placeholder” identifier, or leave the data link identifier field blank. The data table also includes media rendering device types 404, such as a type of the media rendering device 114 (e.g., an audio system 116 and/or a display system 118) that is communicatively linked to the portable electronic device 102 by a corresponding data link. Further, the data table includes the recently-used control interfaces 406, such as any of the media control interfaces 126 that correspond to the respective media rendering device type 404 and associated data link identifier 402. Additionally, the data table includes time-stamps 408 of the last connection of a respective media rendering device to the portable electronic device 102 with an associated data link.

In embodiments, the media manager 136 can reference the data table 400 to correlate an identified data link 122 to a media rendering device type(e.g., by the correlation of a data link identifier 402 with a media rendering device type 404). In an event that a data link identifier 402 is duplicated in the data table 400, such as when a particular data link is first utilized to communicatively link the portable electronic device 102 with an audio rendering device, and then subsequently utilized to communicatively link the portable electronic device with a different, audio and/or video rendering device, the media manager 136 can resolve priority by deferring to the latest time-stamp 408 for a particular connection, or by the most-recent entry of the two in the data table. Alternatively, the media manager 136 may initiate displaying the media control selection menu 128, from which a user can then reconfigure and/or select the desired media control interface 126.

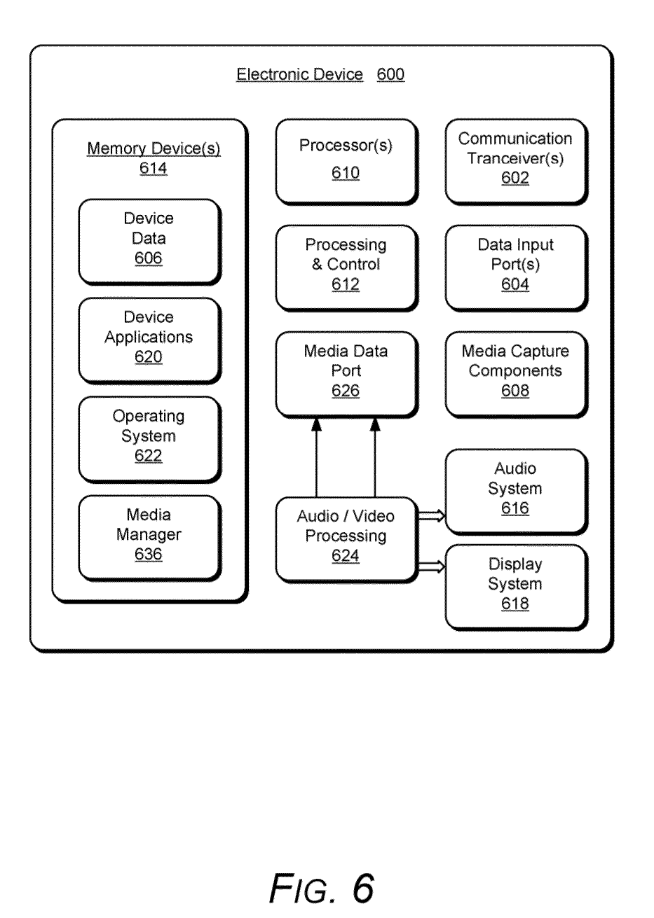

Example method 500 is described with reference to FIG. 5 in accordance with one or more embodiments of content control based on data link context. Generally, any of the methods, components, and modules described herein can be implemented using software, firmware, hardware (e.g., fixed logic circuitry), manual processing, or any combination thereof. A software implementation represents program code that performs specified tasks when executed by a computer processor, and the program code can be stored in computer-readable storage media devices.

FIG. 5 illustrates example method(s) 500 of content control based on data link context. The order in which the method blocks are described are not intended to be construed as a limitation, and any number or combination of the described method blocks can be combined in any order to implement a method, or an alternate method.

At block 502, a data table is maintained that correlates identifiable data links to media rendering devices and types of media control interfaces displayed on a portable electronic device. For example, the portable electronic device 102 (FIG. 1) maintains the data table 138, an example of which is the data table 400 shown and described with reference to FIG. 4. The data table correlates an identifiable data link to a type of media rendering device and a type of the media control interface that was most-recently displayed on the portable electronic device when communicatively linked to the media rendering device. At block 504, the portable electronic device is detected as being communicatively linked to a media rendering device via a data link. For example, the media manager 136 at the portable electronic device 102 detects the data link 122 to the media rendering device 114, such as when a user connects the mobile phone 104 to the display device 120 via the HDMI cable 124. The media manager can also detect the data link 122 to the media rendering device as an identifiable HDMI cable, or as a device dock when the portable electronic device is positioned in the device dock.

At block 506, the data table is referenced to determine whether the data link was previously utilized to communicatively link the portable electronic device to the media rendering device. For example, the media manager 136 at the portable electronic device 102 references the data table 138 to determine whether the data link 122 (e.g., an HDMI cable, an identifiable HDMI cable, or a device dock) was previously utilized to communicatively link the portable electronic device to that media rendering device.

At block 508, a determination is made as to whether the detected data link is an identifiable device dock. For example, the media manager 136 at the portable electronic device 102 determines whether the detected data link 122 is an identifiable device dock from the data table 138, which correlates the device dock and a type of the media control interface that was most-recently displayed on the portable electronic device when positioned in that device dock. If the detected data link is not an identifiable device dock (i.e., “no” from block 508), then at block 510, a determination is made as to whether the detected data link is an identifiable HDMI cable. For example, the media manager 136 at the portable electronic device 102 determines whether the detected data link 122 is an identifiable HDMI cable from the data table 138. Alternatively, the media manager may be implemented to identify whether a particular data link was previously utilized from any other type of memory or data structure utilized to correlate previous data links, the type of connected media rendering device, and the type of media control interface that was most-recently displayed on the portable electronic device when connected via the data link.

If the detected data link is an identifiable device dock (i.e., “yes” from block 508), or if the detected data link is an identifiable HDMI cable (i.e., “yes” from block 510), then at block 512, the most-recently displayed, previous media control interface that correlates to the identifiable data link (e.g., the device dock or the HDMI cable) is determined. For example, the media manager 136 at the portable electronic device 102 determines the most-recently displayed, previous media control interface that correlates to the identifiable data link 122 (i.e., the media control interface that was displayed when the devices were previously connected via the data link). Examples of media control interfaces are shown and described with reference to FIGS. 2 and 3, such as a video control interface 204 (FIG. 2), a music control interface 206, an images slideshow control interface 208, a combination images slideshow and music control interface 302 (FIG. 3), and a video and music control interface 304.

If the detected data link is not identifiable (i.e., “no” from block 510), then at block 514, a determination is made as to whether a media control interface was previously displayed. For example, the media manager 136 at the portable electronic device 102 determines whether one of the media control interfaces was previously displayed when the portable electronic device 102 was communicatively linked to the media rendering device 114 via the data link 122. If a media control interface was previously displayed (i.e., “yes” from block 514), or continuing from a determination of a most-recently displayed, previous media control interface that correlates to an identifiable data link at block 512, the most-recent, previous media control interface is initiated for display on the portable electronic device at block 516.

If a media control interface was not previously displayed (i.e., “no” from block 514), then at block 518, the media manager at the portable electronic device initiates a media control selection menu for display on the portable electronic device. For example, when a user initially connects the portable electronic device 102 to the media rendering device 114 via the data link 122, the media manager 136 detects the data link and initiates the media control selection menu 202 (FIG. 2) for display. The user can then select one of the media control interfaces 126 for display to control playback of media content 106 on the media rendering device, such as the music control interface 132 shown displayed on the mobile phone 104 to control playback of the audio content 108 on the audio system 116. The user may disconnect the portable electronic device from the data link 122 (or disconnect the data link from the media rendering device 114). When the user subsequently connects the portable electronic device to the media rendering device with the data link, such as with the same or a different HDMI cable, the media manager can again detect the data link and initiate the most-recently displayed media control interface, such as the music control interface shown displayed on the mobile phone.

FIG. 6 illustrates various components of an example electronic device 600 that can be implemented as any device described with reference to any of the previous FIGS. 1-5. The electronic device may be implemented as any one or combination of a fixed or mobile device, in any form of a consumer, computer, portable, user, communication, phone, gaming, media playback, and/or electronic device.

The electronic device 600 includes communication transceivers 602 that enable wired and/or wireless communication of device data 606, such as received data, data that is being received, data scheduled for broadcast, data packets of the data, etc. The device data 606 is an example of the media content 106 at the portable electronic device 102 (FIG. 1), and the device data may include the audio content 108, the digital images 110, and/or the video content 112. Example communication transceivers 602 include wireless personal area network (WPAN) radios compliant with various IEEE 802.15 (also referred to as Bluetooth™) standards, wireless local area network (WLAN) radios compliant with any of the various IEEE 802.11 (also referred to as WiFi™) standards, wireless wide area network (WWAN) radios for cellular telephony, wireless metropolitan area network (WMAN) radios compliant with various IEEE 802.15 (also referred to as WiMAX™) standards, and wired local area network (LAN) Ethernet transceivers.

The electronic device 600 may also include one or more data input ports 604 via which any type of data, media content, and/or inputs can be received, such as user-selectable inputs, messages, music, television content, recorded video content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the electronic device to components, peripherals, or accessories such as microphones or cameras. Additionally, the electronic device 600 may include media capture components 608, such as an integrated microphone to capture audio and a camera to capture still images and/or video media content.

The electronic device 600 includes one or more processors 610 (e.g., any of microprocessors, controllers, and the like), which process computer-executable instructions to control operation of the device. Alternatively or in addition, the electronic device can be implemented with any one or combination of software, hardware, firmware, or fixed logic circuitry that is implemented in connection with processing and control circuits, which are generally identified at 612. Although not shown, the electronic device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The electronic device 600 also includes one or more memory devices 614 that enable data storage, examples of which include random access memory (RAM), non-volatile memory (e.g., read-only memory (ROM), flash memory, EPROM, EEPROM, etc.), and a disk storage device. A disk storage device may be implemented as any type of magnetic or optical storage device, such as a hard disk drive, a recordable and/or rewriteable disc, any type of a digital versatile disc (DVD), and the like. The electronic device 600 may also include a mass storage media device.

A memory device 614 provides data storage mechanisms to store the device data 606, other types of information and/or data, and various device applications 620 (e.g., software applications). For example, an operating system 622 can be maintained as software instructions within a memory device and executed on the processors 610. The device applications may also include a device manager, such as any form of a control application, software application, signal-processing and control module, code that is native to a particular device, a hardware abstraction layer for a particular device, and so on. In embodiments, the electronic device also includes a media manager 636 that implements content control based on data link context. The media manager 636 is an example of the media manager 136 at the portable electronic device 102 shown in FIG. 1.

The electronic device 600 also includes an audio and/or video processing system 624 that generates audio data for an integrated audio system 616 and/or generates display data for an integrated display system 618. The audio system and/or the display system may include any devices that process, display, and/or otherwise render audio, video, display, and/or image data. Additionally, or alternately, display data and audio signals can be communicated via media data port 626 to an external audio component and/or to an external display component via an RF (radio frequency) link, S-video link, HDMI (high-definition multimedia interface), composite video link, component video link, DVI (digital video interface), analog audio connection, or other similar communication link. For example, the media data port 626 can convey audio data and display data to the audio system 116 and display system 118 of the media rendering device 114 shown in FIG. 1.

As described above, content control based on data link context provides that a most-recent, previously displayed media control interface (e.g., a music control interface, an images slideshow control interface, a video control interface, or combination thereof) can be automatically displayed on a portable electronic device, such as a mobile phone, when a data link to a peripheral media rendering device is detected. An identifiable data link, such as a device dock or identifiable HDMI cable, can be detected when the portable electronic device is connected to a media rendering device, and the most-recent, previously displayed media control interface that correlates to the identified data link can be initiated for display on the portable electronic device. Alternatively, a non-identifiable data link, such as an HDMI cable or other non-identifiable communication link, can be detected when the portable electronic device is connected to the media rendering device, and the most-recent, previously displayed media control interface can be initiated for display on the portable electronic device. Alternatively, the non-identifiable data link can be detected and if a media control interface has not been recently displayed, a media control selection menu can be initiated for display as a user interface, from which a user can then select one or a combination of the media control interfaces.

Although embodiments of content control based on data link context have been described in language specific to features and/or methods, the subject of the appended claims is not necessarily limited to the specific features or methods described. Rather, the specific features and methods are disclosed as example implementations of content control based on data link context.

1. A method implemented at a portable electronic device, the method comprising:
detecting the portable electronic device communicatively linked to a media rendering device via a data link;
determining whether the data link was previously utilized to communicatively link the portable electronic device to the media rendering device; and
initiating one of:
a media control selection menu for display on the portable electronic device if the data link was not previously utilized; or a media control interface for display on the portable electronic device if the data link was previously utilized, the media control interface configured for user-selection to control media content that is rendered by the media rendering device.

2. The method as recited in claim 1, wherein the media control interface is configured as one or more of: a video control interface, a music control interface, or an images slideshow control interface.

3. The method as recited in claim 2, wherein the media control selection menu is configured for user-selection to select one or more of: the video control interface, the music control interface, or the images slideshow control interface.

4. The method as recited in claim 1, further comprising:
determining that the media control interface was most-recently displayed responsive to said detecting the portable electronic device being communicatively linked to the media rendering device, and wherein said initiating the media control interface for display is the most-recently displayed responsive to said detecting the portable electronic device being communicatively linked to the media rendering device.

5. The method as recited in claim 1, further comprising:
maintaining a data table that correlates an identifiable data link to the media rendering device and a type of the media control interface that was most-recently displayed on the portable electronic device.

6. The method as recited in claim 5, further comprising:
referencing the data table to determine whether the data link was previously utilized to communicatively link the portable electronic device to the media rendering device.

7. The method as recited in claim 1, wherein the media control interface is initiated for control of the media content that is maintained on the portable electronic device and rendered by the media rendering device.

8. The method as recited in claim 7, further comprising:
detecting an HDMI cable at an HDMI data port of the portable electronic device, and wherein said initiating the media control selection menu for display is based on the detecting.

9. The method as recited in claim 8, further comprising:
identifying the HDMI cable, and wherein said initiating the media control interface for display is based on the identifying.

10. The method as recited in claim 1, wherein the data link comprises one of: an HDMI cable, an identifiable HDMI cable, or a device dock for the portable electronic device that communicatively links to the media rendering device.

11. A portable electronic device, comprising:
an integrated display configured to display a media control selection menu from which media control interfaces are selectable for display;
at least a memory and a processor configured to execute a media manager that is configured to:
detect a data link to an external media rendering device;
determine whether the data link was previously utilized to communicatively link the portable electronic device to the external media rendering device; and
initiate one of: the media control selection menu for display if the data link was not previously utilized, or a media control interface for display and configured for user-selection to control media content that is rendered by the external media rendering device if the data link was previously utilized.

12. The portable electronic device as recited in claim 11 wherein:
the media control interface is configured as one or more of: a video control interface, a music control interface, or an images slideshow control interface; and
the media control selection menu is configured for user-selection to select one or more of the video control interface, the music control interface, or the images slideshow control interface.

13. The portable electronic device as recited in claim 11, wherein the media manager is further configured to:
determine the media control interface that was most-recently displayed; and
initiate the media control interface for display if the data link to the external media rendering device is detected.

14. The portable electronic device as recited in claim 11, wherein the media manager is further configured to access the memory to read a data table that correlates an identifiable data link to the external media rendering device and a type of the media control interface that was most-recently displayed on the portable electronic device.

15. The portable electronic device as recited in claim 11, wherein the media control interface is initiated to control the media content that is maintained on the portable electronic device and rendered by the external media rendering device.

16. The portable electronic device as recited in claim 11, wherein the data link comprises one of: an HDMI cable, an identifiable HDMI cable, or a device dock for the portable electronic device that communicatively links to the external media rendering device.

17. The portable electronic device as recited in claim 16, wherein the media manager is further configured to detect the HDMI cable at an HDMI data port of the portable electronic device, and wherein said initiate the media control selection menu for display is based on the media manager detecting the HDMI cable.

18. The portable electronic device as recited in claim 16, wherein the media manager is further configured to identify the identifiable HDMI cable, and wherein said initiate the media control interface for display is based on the media manager identifying of the identifiable HDMI cable.

19. A method implemented at a portable electronic device, the method comprising:
detecting a data link to an external media rendering device;
identifying the data link as having been previously utilized to communicatively link the portable electronic device to the external media rendering device;
determining a type of media control interface most-recently displayed for use on the portable electronic device when communicatively linked to the external media rendering device via the data link; and
initiating a media control interface of the type of media control interface for display on the portable electronic device, the media control interface configured for user-selection to control media content that is maintained on the portable electronic device and transmitted via the data link to be rendered by the external media rendering device.

20. The method as recited in claim 19, wherein the media control interface is displayed on the portable electronic device as one or combination of:
a video control interface configured for video playback control of video content that is transmitted via the data link to be displayed by the external media rendering device;
an audio control interface configured for audio playback control of audio content that is transmitted via the data link to be rendered as audio by the external media rendering device; or
an images slideshow control interface configured for slideshow control of digital images that are transmitted via the data link to be displayed by the external media rendering device.
